(19) United States
(12) Patent Application Publication
(10) Pub. No.: US 2016/0003282 A1
(43) Pub. Date: Jan. 7, 2016

(54) Method for Producing a Concrete Screw

(71) Applicant: Hilti Aktiengesellschaft, Schaan (LI)

(72) Inventors: Tobias NEUMAIER, Rankweil (AT); Corinna ACHLEITNER, Bludenz (AT); Guenter DOMANI, Weissensberg (DE); Mark WINKLER, Hohenems (AT)

(73) Assignee: Hilti Aktiengesellschaft, Schaan (LI)

(21) Appl. No.: 14/770,410

(22) PCT Filed: Feb. 12, 2014
(86) PCT No.: PCT/EP2014/052680

§ 371 Date: Aug. 25, 2015

(30) Foreign Application Priority Data
Feb. 26, 2013 (DE) 10 2013 203 150.5

(51) Int. Cl. F16B 25/00; B21H 3/02

(52) U.S. Cl. CPC F16B 25/0026; B21H 3/022; B21H 3/027; F16B 25/0084

(57) ABSTRACT

A method for producing a concrete screw is disclosed. The method includes providing a wire piece as a workpiece, forming a thread helix on a lateral surface of the workpiece, and providing a depression in the lateral surface of the workpiece by a forming process.

This application claims the priority of International Application No. PCT/EP2014/052680, filed Feb. 12, 2014, and German Patent Document No. 10 2013 203 150.5, filed Feb. 26, 2013, the disclosures of which are expressly incorporated by reference herein.

### BACKGROUND AND SUMMARY OF THE INVENTION

The invention relates to a method for producing a concrete screw comprising a shank and a thread arranged on the lateral surface of the shank, wherein in a tip region of the concrete screw, there is provided at least one cutting recess in the lateral surface of the shank. In such a method, it is provided that

A piece of wire is provided as a workpiece,
At least one thread helix is formed on to the lateral surface of the workpiece, and
At least one depression is placed into the lateral surface of the workpiece.

A method of the type in question is known from US 2011274516 A. This specification teaches a production method for a concrete screw in which initially a thread is formed on a shank, and on which subsequently, notches are milled out of the shank by means of diagonally placed milling wheels. The milled-out notches, which represent a likeness of the milling wheels, are bounded by sharp edges. As is explained for example in EP 2 233 757 A2, these edges may serve as cutting edges, which can expand a non-perfect cylindrical borehole when screwing in a screw, and that can thereby enable one to set concrete screws having relatively large core diameters and thus relatively high load capacities.

The object of the invention is to indicate a production method for concrete screws with which high-performance concrete screws can be produced in a particularly simple and cost-effective manner.

A method according to the invention is characterized in that the depression is placed in the lateral surface of the workpiece by forming, particularly by cold-forming.

A basic concept of the invention may be perceived in that the depression in the lateral surface of the workpiece, which forms the cutting recess in the finished concrete screw, is not formed by a cutting milling process, but by a forming process, in other words by a non-cutting production process, in which the workpiece is malleably altered permanently in terms of its shape, while retaining its mass and its consistency. Within the scope of the invention, it was recognized that the milling process taught in US 2011274516 A for producing the cutting recesses for the functionality of the finished screws generally does play a subordinate role. Building on this knowledge, the invention proposes to produce at least one depression not in a cutting milling process but in a non-cutting forming process. Such a non-cutting forming process has several advantages. First of all, in this way a non-cutting forming process can be easily integrated into the production sequence of the screw and be combined with other steps. For example, the depression can be formed in the same step in which the screw head is also formed. A separate cutting production step for forming in the depression can thus be omitted, which can significantly shorten the production sequence and reduce the manufacturing costs. In addition, a non-cutting forming process is less intensive in terms of raw materials and waste, which can further decrease the manufacturing costs. Lastly, in a cold-forming process, the area of the cutting recesses can be hardened without any additional production steps by means of cold-hardening, so that with little effort one can achieve particularly good cutting durability and thereby reliability.

With the method according to the invention, a concrete screw is produced, in other words a screw with a self-tapping thread, which can be screwed into a concrete substrate while forming a counter thread. Preferably, at least one thread helix forms, if applicable after subsequent machining, the thread in the finished screw, and/or the depression in the lateral surface of the workpiece forms, if applicable after subsequent machining, the cutting recess in the finished concrete screw. The invention is particularly suited for producing concrete screws with a relatively thick shank, in other words for those screws in which the ratio of the exterior diameter of the thread to the exterior diameter of the shank is 1.1 to 1.4, for example. The workpiece and/or the concrete screw consist preferably of a metal material.

The shank and/or the workpiece expediently has at least in sections a cylindrical lateral surface. The tip region of the concrete screw may refer in particular to the region which, in the intended use of the concrete screw, is first inserted in the borehole, in other words the region at which the self-tapping thread begins.

Preferably, according to the invention, all depressions which are placed to form cutting recesses in the lateral surface of the workpiece, can be shaped by forming. However, basically it would also be conceivable to make a portion of the depressions in a non-cutting manner by forming and another portion in a cutting manner, for example by milling. If necessary, the depression placed in the lateral surface of the workpiece according to the invention by forming can also be dressed, and this either in a non-cutting or also cutting manner.

An advantageous development of the invention consists of first placing the depression in the lateral surface of the workpiece and then forming the thread helix on the lateral surface of the workpiece. The thread helix is thus first formed on when the depression is already in place. Since according to this embodiment and after producing the thread helix, great, and thus for the thread helix, potentially damaging forces are no longer required to act on the workpiece, a particularly high thread precision can hereby be achieved and thereby a particularly good settability and particularly good load capacity. In addition, as explained in greater detail below, it is possible with this embodiment to use the production process for the thread helix simultaneously for dressing the depression. In particular, it is advantageous that the geometry of the depression is modified when forming on the thread helix. According to this embodiment, when forming on the thread helix, not only is the region of the thread helix deformed, but so is the depression, so that particularly advantageous component shapes can be obtained in a particularly simple manner.

Basically the thread helix could be formed on by thread cutting. However, it is particularly preferred that the thread helix is formed on in a thread rolling process. This may be advantageous in terms of costs and production speed. In addition, by means of thread rolling, thread helixes can be obtained that are particularly well suited for concrete screws. In a thread rolling process, the thread helix is formed in a non-cutting manner, particularly by cold-forming. In a thread rolling process, at least one profiled rolling tool, preferably at least two profiled rolling tools, acts or act respectively on the workpiece and causes or cause respectively the workpiece to rotate in a workpiece rotational direction. The shaping is based on pressure loads that are generated by the rolling tool in the workpiece, wherein the profile of the rolling tools is reproduced on the workpiece.

Preferably, a flat-die rolling process is provided as a thread rolling process, in which two flat rolling dies, which are moved in a linear manner to each other, act as rolling tools on the workpiece. In an alternative method execution, at least two rolls can act as rolling tools on the workpiece. In another alternative method execution, one roll and a corresponding segment can act as rolling tools on the workpiece.

Another advantageous development of the invention lies in that the rolling tool acts at least on a sub-region of the edge of the depression and deforms it. According to this embodiment, during the thread rolling process, not only is the thread helix produced, but pressure forces are generated in the edge region of the depression that deform the edge of the depression. The rolling tool is thus constructed to be large enough that it extends to the depression so that the depression is lapped in the thread rolling process. Iₜ was observed that the material at the depression can hereby flow in a manner partially tangential to the rolling direction. Furthermore, it was surprisingly noted that at the edge of the depression, a sharp cutting edge can hereby be generated, which forms an undercut and which under certain circumstances partially covers the depression radially outwardly. In tests, it was discovered that the cutting edge may have a radius of only 0.1 to 0.4 mm. The sharp edge of the cutting edge can ensure that a rough and non-perfect cylindrical borehole is straightened and expanded in a particularly reliable manner. In this way, particularly concrete screws with a ratio between the drill bit nominal diameter and the thread core diameter of 0.9-1.1 can be very settable.

Another expedient variant of the method according to the invention lies in that the depression, which is made in the lateral surface of the workpiece, is asymmetric when observed in a cross-sectional perspective of the workpiece. In particular, the depression may be asymmetric relative to the radial direction of the workpiece and/or the screw. By means of the asymmetric design of the depression, the depression may be optimized in terms of the subsequent deformation in the rolling process so that a particularly usable final shape of the depression, and thereby a particularly usable shape of the thus formed cutting recess, can be obtained. By means of an asymmetric design of the depression, the forming resistance when making the depression can also be reduced, without greatly impairing the function of the finished screw. Cross-section may refer in particular to a cut perpendicular to the longitudinal axis of the workpiece and/or the screw.

It is particularly advantageous that a leading flank of the depression in the screw-in direction of the thread helix, when viewed in the cross-sectional perspective of the workpiece, runs flatter relative to the lateral surface of the workpiece than a trailing flank of the depression in the screw-in direction. The flank trailing in the screw-in direction is that flank which, in the finished concrete screw, cuts the concrete when screwed in. At this flank, a steep angle is advantageous for a good cutting action. The opposite flank of the depression leading in the screw-in direction on the other hand generally has at best a subordinate cutting function. This flank is preferably constructed to be flat, since the depression can hereby be furnished with a large surface area so that the cutting recess resulting from the depression can accommodate concrete dust in a particularly reliable manner, even if the flanks are deformed when lapping the depression. A flat flank progression may refer to the flank, from a cross-sectional perspective of the workpiece, enclosing only a small angle with a tangent to the lateral surface of the workpiece, which originates at the transition of the lateral surface into the flank.

It is particularly expedient that the concrete screw has a broadened screw head relative to the shank. This screw head may be used for the rotationally fixed coupling with a setting tool. For rotationally fixed coupling with a setting tool, the screw head may have for example a polygonal structure, preferably an external hexagonal head.

In this context, it is advantageous that the workpiece is upset and an end-side thickening is thereby produced. The end-side thickening can be formed to the screw head of the finished screw or can already form the screw head directly.

The production cost can be reduced by the end-side thickening being produced or formed simultaneously with the placing of the depression in the lateral surface of the workpiece. To this end and using a punch, one can apply an axial force on the end of the workpiece, at which the thickening is being formed, wherein the axial force drives the workpiece into a die plate that forms the depression.

Furthermore, it is advantageous that the depression is put in by pressure forming, particularly by extrusion molding. This is also advantageous in regard to the production cost. According to the definition, a pressure forming process refers to a forming under prevailing pressure loads. For placing the depression, the workpiece is pressed into or through a die plate in a suitable manner.

The depression is expediently made in an end region of the workpiece in the lateral surface of the workpiece, particularly in an end region, which lies opposite the thickening. It is preferred that the depression is open to the front face of the workpiece. This allows for particularly simple production by means of a die plate. Accordingly, it is particularly preferred that the cutting recess of the finished screw is open to the front face of the screw.

According to the invention, for example two to six, preferably four, depressions may be provided in the workpiece, corresponding to two to six, preferably four, cutting recesses in the concrete screw. In particular an even number of depressions, corresponding to an even number of cutting recesses, may be provided. The relatively high symmetry resulting hereby may be particularly advantageous for force absorption.

The wire piece, upon which the method according to the invention is based, expediently has a circular cross-section according to the invention. Preferably, the wire piece is constructed to be cylindrical, preferably circularly cylindrical, particularly in the shape of a straight circular cylinder.

The invention also relates to a concrete screw that is produced in a method according to the invention. In particular, such a screw may have at the edge of the cutting recess a cutting edge, which forms an undercut, i.e., which partially covers the cutting recess outwardly. The thread is preferably a right-hand thread.

The invention is explained in greater detail below by means of preferred exemplary embodiments, which are depicted schematically in the attached drawings, wherein individual features of the subsequently depicted exemplary embodiments may be executed in conjunction with the invention individually or in any combination. Schematically depicted in the drawings are:

### BRIEF DESCRIPTION OF THE DRAWINGS

FIGS. 1 to 5: A workpiece in various sequential stages during the production sequence of a first embodiment of a method according to the invention; FIGS. 1 to 4 illustrate a side view and FIG. 5 illustrates a perspective view, whereby FIG. 5 depicts a concrete screw according to the invention as an end product.

FIG. 6: The rolling die arrangement from FIG. 4 in a perspective view, wherein for clarity's sake the end-side thickening, which forms the screw head, is not shown.

FIG. 7: A cross-sectional view A-A of the workpiece in the region of the depression in the stage of FIG. 3 and, in an exemplary manner on a depression in a dotted line superimposed on it, in the stage of FIG. 5; and

FIG. 8: A cross-sectional view analogous to FIG. 7 according to a second embodiment of the method according to the invention.

### DETAILED DESCRIPTION OF THE DRAWINGS

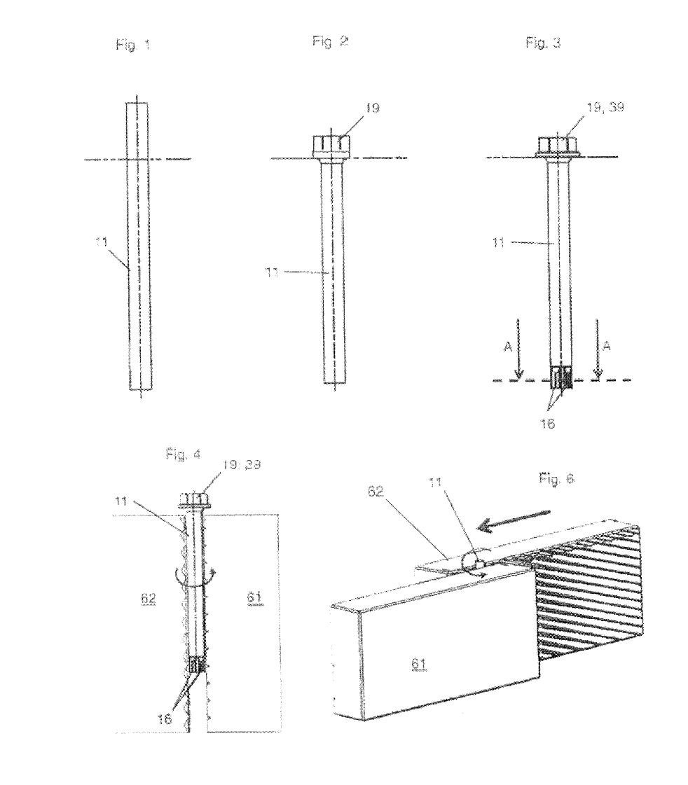

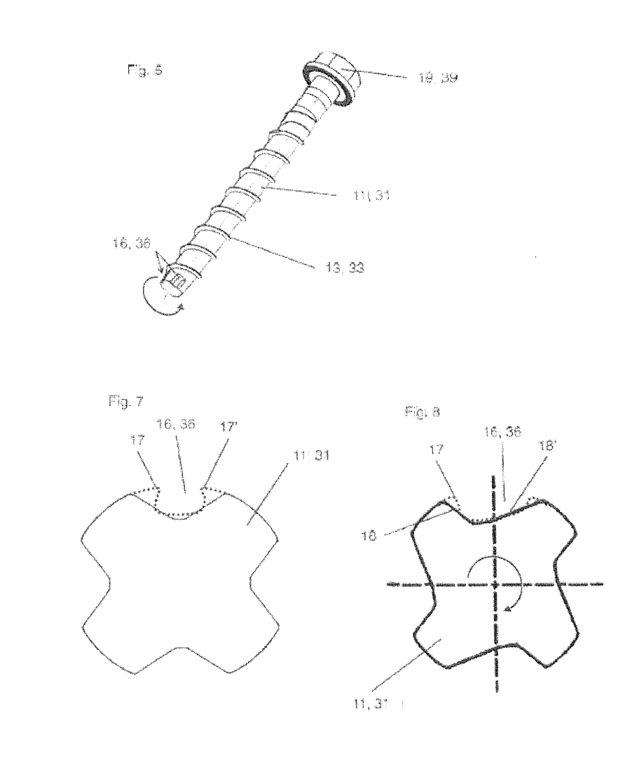

FIGS. 1 to 7 illustrate a first exemplary embodiment of a method according to the invention, wherein FIGS. 1 to 5 depict a sequence of stages from the unprocessed wire piece (FIG. 1) to the finished end product (FIG. 5).

As FIG. 1 shows, the method begins with a straight piece of metal wire being provided as workpiece 11.

In the following method step, a thickening 19 with an external hexagonal structure is upset on an end of workpiece 11 and thereby the intermediate product shown in FIG. 2 is obtained.

In the next method step, the thickening 19 is further formed into a screw head 39. In the same method step and on the end of the workpiece 11, which is opposite the thickening 19, four depressions 16 are formed into the cylindrical lateral surface of the workpiece 11 by means of a forming process, for example by pressing the end of the workpiece 11, which is opposite the thickening 19, into a die plate. The intermediate product obtained hereby is depicted in FIG. 3 and with a solid line in FIG. 7.

Thereupon, the workpiece 11, as shown in FIGS. 4 and 6, is put between two rolling tools 61 and 62, which are constructed as profiled thread rolling dies. In the depicted exemplary embodiment, the first rolling tool 61 is stationary, whereas the second rolling tool 62 is moved linearly in the direction of the arrow in FIG. 6. The workpiece 11 is hereby set into rotation in the workpiece rotational direction shown in FIG. 6.

By means of the rolling tools 61 and 62, a thread helix 13 or also multiple thread helices are formed on to the cylindrical lateral surface of the workpiece 11. The product obtained hereby is shown in FIG. 5. However, the rolling tools 61 and 62 also act on the edge regions of depressions 16. As a result, a material flow into depressions 16 occurs at the edge regions of depressions 16. As a consequence, cross-sectional shapes are created as depicted in FIG. 7, with the example of the upper depression 16, in a dotted line. In particular, sharp cutting edges 17 and 17′, preferably with an opening angle of less than 10°, may result that form the undercuts and partially cover the depression 16 outwardly.

The stage shown in FIG. 5 and as a dotted line in FIG. 7 simultaneously represent the end product. In the end product, i.e., in the concrete screw, the thickening 19 forms the screw head 39 and the thread helix 13 forms the thread 33 of the concrete screw. The formed depressions 16 form the cutting recesses 36 in the shank 31. In this way, the sharp cutting edges 17 and/or 17′ are also found on the cutting recesses 36, i.e., the cutting recesses 36 are preferably covered outwardly in sections by at least one cutting edge 17 or 17′.

A modified embodiment of the method according to the invention is shown in FIG. 8. As FIG. 8 shows, the depressions 16 in the lateral surface of the workpiece 11 may also be constructed asymmetrically in the cross-section of the workpiece 11. In particular, that flank 18, which trails in the screw-in direction defined by the thread helix 13 and marked in FIGS. 5 and 8 with an arrow, may be constructed more steeply than the opposing flank 18′. In this way, that flank 18, which acts against the surrounding substrate when screwing in the finished screw, may develop a good cutting action, wherein, because of the flat construction of the second flank 18′ even after lapping the depression 16 (dotted line in FIG. 8), a large access area in the cutting recess 36 exists, which permits a reliable material transport of concrete dust into the cutting recess 36. The screw-in direction may be opposite particularly from the workpiece rotational direction during thread rolling.

1.-9. (canceled)

10. A method for producing a concrete screw, comprising the steps of:
providing a wire piece as a workpiece;
forming a thread helix on to a lateral surface of the workpiece; and
providing a depression in the lateral surface of the workpiece by a forming process.

11. The method according to claim 10, wherein the step of providing the depression is performed and subsequently the step of forming the thread helix is performed.

12. The method according to claim 11, wherein a geometry of the depression is changed when forming the thread helix.

13. The method according to claim 12, wherein the thread helix is formed in a thread rolling process, wherein during the thread rolling process a profiled rolling tool acts on the workpiece and sets the workpiece in motion in a workpiece rotational direction, and wherein the rolling tool acts on a sub-region of an edge of the depression and deforms the depression.

14. The method according to claim 13, wherein the depression is asymmetric in a cross-sectional perspective of the workpiece, wherein a flank of the depression leading in a screw-in direction of the thread helix runs flatter in relation to the lateral surface than a flank of the depression trailing in the screw-in direction.

15. The method according to claim 10, wherein the concrete screw has a screw head that is broadened relative to a shank of the concrete screw and is formed from an end-side thickening.

16. The method according to claim 15, wherein the screw head is formed simultaneously with the providing of the depression in the lateral surface of the workpiece.

17. The method according to claim 10, wherein the depression is open toward a front face of the workpiece and is made by extrusion.

18. The method according to claim 10, wherein the forming process is a non-cutting production process.

19. The method according to claim 10, wherein the forming process is not a cutting milling process.

20. A concrete screw produced by a method according to claim 10.
